(19) United States
(12) Patent Application Publication
(10) Pub. No.: US 2023/0339813 A1
(43) Pub. Date: Oct. 26, 2023

(54) POLYURETHANE BASED POLYMER CONCRETES AND GROUTING MORTARS OF CONTROLLED DENSITY

(71) Applicant: SIKA TECHNOLOGY AG, Baar (CH)

(72) Inventors: Steffen KELCH, Oberengstringen (CH); Tim MAMIE, Zürich (CH)

(73) Assignee: SIKA TECHNOLOGY AG, Baar (CH)

(21) Appl. No.: 18/026,712

(22) PCT Filed: Nov. 22, 2021
(86) PCT No.: PCT/EP2021/082436

§ 371 Date: Mar. 16, 2023

(30) Foreign Application Priority Data
Nov. 26, 2020 (EP) 20210147.3

(51) Int. Cl. C04B 26/16; C04B 14/04; C04B 14/28; C04B 22/14; C04B 14/06; C04B 40/06; C04B 38/10; C04B 38/00

(52) U.S. Cl. CPC C04B 26/16; C04B 14/047; C04B 14/28; C04B 22/142; C04B 14/06; C04B 40/065; C04B 38/10; C04B 38/0051; C04B 2103/465

(57) ABSTRACT

The use of a desiccant for influencing the density of a curable binder composition including a) at least one organic binder including a polyisocyanate and a polyol, and b) at least 50% by weight of an inorganic filler F, more particularly in the form of quartz aggregates and/or slag, the proportions by weight being based on 100% by weight of the binder composition.

### TECHNICAL FIELD

The invention relates to the selective influencing of the density of a curable binder composition comprising: a) at least one organic binder and b) a filler. The invention further relates to a curable binder composition and also to a multicomponent system for producing such a curable binder composition and to a cured binder composition or a cured multicomponent system.

### PRIOR ART

Polymer concrete is a material impermeable to water that typically comprises an organic binder and fillers. Unlike normal concrete, in which the cement as binder holds the fillers together after hardening with water, in polymer concrete an organic polymer acts as a binder that ensures the cohesion of the material after chemical curing. Polymer concrete typically does not contain any cement as a binder. The filler in polymer concrete typically consists of natural rock, for example granite, quartz, basalt, limestone, expanded clay, perlite or other mineral raw materials, such as slag from metal production or recycled solid building materials, in varying grain sizes. Fillers are employed to alter the mechanical, electrical and/or processing properties of materials and at the same time to considerably reduce the proportion of the typically more costly matrix in the finished product. In addition, the presence of the filler grains ensures that the shrinkage in volume of the polymer concrete after curing of reactively crosslinking polymer matrices is significantly reduced and that the compressive strength thereof is assured.

The curable liquid organic binder, typically consisting of at least two reactive components, is normally mixed with the filler after the binder components have been mixed, and then shaped by casting and allowed to cure.

Examples of known organic binders are epoxy resin-based systems, polyurethane-based systems, unsaturated polyester resins or acrylic resins.

In epoxy-resin-based polymer concrete, the curable binder consists of a curable epoxy resin and a curing agent for the epoxy resin, which react after mixing to form a cured epoxy resin. In polyurethane-based polymer concrete, the curable binder consists of a polyisocyanate and a polyol, which react after mixing to form a chemically crosslinked polyurethane.

Polymer concretes based on epoxy resins or polyurethanes are characterized by high strength, frost resistance, abrasion resistance, and material resistance, and also by a closed and waterproof surface. However, known polymer concretes based on epoxy resins or polyurethanes exhibit only limited stability under corrosive conditions.

The growing demand for building materials, as well as environmental protection requirements, results in a shortage of natural mineral raw materials capable of being used as fillers. This applies in particular to quartz aggregates, such as quartz powder, quartz sand, and quartz gravel. There are therefore efforts to increasingly replace natural raw materials with industrial waste materials.

GB 2460707 describes the use of recycled material as aggregate for polymer concrete. Glass sand, plastic beads, crushed porcelain or recycled polymer concrete are used as partial substitutes for natural rocks.

An industrial waste material that occurs in large amounts around the world is slag. It occurs for example in the extraction of metals, in metal recycling or in the incineration of household waste or sewage sludge. Foundry sand, a glassy slag from iron production, is on account of its latent hydraulic properties used in finely ground form as an additive in cement and as a cement substitute. Other slags, such as steel slag formed in steel production or steel recycling, or copper slag that occurs in copper production, are less suitable as a cement substitute because of their poor hydraulic properties. Like blast furnace slag, they are sometimes used as gravel in road construction, as inexpensive backfill material or, in the case for example of copper slag, as abrasives.

WO 2010/030048 describes the use of “atomized steel slag” as a constituent of polymer concrete based on an unsaturated polyester resin. This “atomized steel slag” is produced by a special process that gives rise to additional costs, making the slag more costly. Atomized steel slag has only limited availability in terms of both amount and location.

Conventional fillers such as quartz aggregates cannot readily be replaced by industrial waste materials in known polymer concretes. Depending on the nature of the industrial waste materials, partial or complete replacement can result in undesirable changes in the physical and chemical properties of polymer concretes.

Foamed polymer concretes are also known. Foamed concretes are generally employable for lightweight constructions or as a material for thermal insulation.

US 2017/7174569 A1 describes for example a foamable polymer concrete in which water is added to a polyurethane mixture in order to provoke a foaming reaction. However, the foaming reaction can be controlled here only to a very limited extent.

There is accordingly still a need for new approaches and improved solutions in the field of polymer concretes in which the abovementioned disadvantages are as far as possible absent.

### SUMMARY OF THE INVENTION

It is an object of the present invention to provide improved polymer concretes and casting compounds and also processes for the production thereof. More particularly, it should be possible to produce polymer concretes that have a controlled density and/or foam structure and at the same time properties that are as advantageous as possible. Also desirable is the ability to use for the production of polymer concretes both conventional fillers and industrial waste materials that are as far as possible available globally and do not require any laborious processing.

This object is surprisingly achieved by a use as described in claim 1.

As has surprisingly been found, the density of a curable binder composition comprising a polyurethane-based binder and inorganic filler F can be directly controlled, more particularly increased, by adding a desiccant. The more desiccant that is added, the less the binder composition foams during curing and the fewer bubbles that are formed, and the density of the material increases. The degree of foaming and the density can be controlled very precisely without adversely affecting the curing reaction of the organic binder. Moreover, the presence of a desiccant results in a more fine-pored and more homogeneous structure being achieved than in the absence of a desiccant.

Without being bound by any particular theory, the addition of desiccant should reduce intrinsic bubble formation in the organic binders during curing and/or bring about a more even distribution of the bubbles as a result of the gases concerned interacting with the desiccant and/or being at least partially absorbed in the desiccant. The latter occurs especially when molecular sieves are used as desiccants. The desiccant accordingly influences the pore structure that results from the formation of bubbles in the cured binder composition, in particular the pore density is reduced, the pore shape becomes more uniform, and the pore size distribution becomes more uniform.

As has been found, the use according to the invention of a desiccant makes it possible to produce highly pressure-resistant foam structures having characteristic pore structures with finely dispersed pores in the range of 1.0 mm and below.

The selective addition of the desiccant allows the volume of the cured binder composition to be altered, more particularly reduced, by up to 40% by volume, depending on the content of freely available water. At the same time, the densities of the cured binder compositions can be altered, more particularly increased, by up to 30%. This in both cases by comparison with a corresponding curable binder composition produced without addition of a desiccant.

Accordingly, the desiccant can be used to influence, more particularly to increase, the density of the curable binder composition in the cured state. This is more particularly achieved by reducing the pore content in the curable binder composition.

In addition, the desiccant can be used to influence, more particularly to reduce, bubble formation and/or foaming in the curable binder composition.

Moreover, the control over foaming afforded by the addition of desiccant makes it possible also to selectively influence the thermal conductivity of the cured binder compositions.

More pronounced foaming or an increase in pore density in the cured binder compositions is, as expected, accompanied by a decrease in mechanical strength. This is however unexpectedly minor in extent, with good mechanical strengths still achieved even in the case of strongly foamed, cured binder compositions having low densities.

Binder compositions based on polyisocyanate and polyol also have the advantage over other organic binder compositions that are also used for polymer concrete, more particularly over unsaturated polyester resins or acrylic resins, of being readily processable and reactively curable even at low temperatures of for example 5° C. or 10° C., as well as having good casting and leveling properties. Also, unlike the often highly viscous unsaturated polyester resins, curing does not necessitate the use of initiators that are an explosion hazard, such as peroxides. In addition, the surface of the cured polyurethane-based binder composition is firm and nontacky, in contrast to unsaturated polyester resins, in which the surface often hardens only slowly or incompletely.

Compared to epoxy resin-based compositions having the same concentration by weight of fillers, the inventive polyurethane-based compositions and polymer concretes or grouting compounds obtainable therefrom typically have slightly lower/reduced compressive and flexural strength on account of the flexibility of the polyurethane matrix after curing (7 d at room temperature). However, compared to the epoxy resin-based reference material the polyurethane-based compositions of the invention have much less pronounced swellability in water and significantly higher chemical and mechanical stability to the action of corrosive media, in particular to dilute organic acids such as aqueous acetic acid.

Specifically, it has been shown that—even if in permanent contact either with acidic aqueous solutions (pH<7) or with neutral aqueous solutions (pH=7) and basic aqueous solutions (pH>7)—the compressive strengths of polyurethane-based polymer concretes and casting compounds remain essentially stable for weeks or even cure further.

This contrasts with epoxy resin-based compositions produced for test purposes, which likewise cure further to some degree on contact with basic aqueous solutions but, in contact with acidic or neutral aqueous solutions, show a sharp fall in compressive strength over time and clearly visible surface erosion.

Polyurethane-based compositions therefore exhibit high stability to corrosion irrespective of the pH of corrosive media. This is a major advantage, because polymer concretes can typically come into contact with both alkaline and acidic solutions under the respective conditions of use. This is the case for example when polyurethane-based casting compounds are used in combination with cementitious materials from which alkaline substances can be leached out and when casting compounds come into contact from time to time with acidic cleaning agents, foodstuffs or feces, especially urine.

The recited advantages of polyurethane-based compositions can be realized both with conventional fillers, for example quartz aggregates, and with industrial waste materials, in particular slags, which are inexpensive and available globally. Slags are particularly advantageous here, which means that quartz aggregates can be dispensed with altogether if necessary.

It is surprisingly possible to use slag as filler in high proportions in polyurethane-based compositions without loss of quality.

Slag is a waste material from metal extraction, metal recycling or waste incineration and occurs in very large amounts worldwide. Its use in the polyurethane-based compositions of the invention helps reduce landfill waste and reduces the need for high-quality natural aggregates, the availability of which is progressively diminishing.

Polyurethane-based polymer concretes and casting compounds that contain slag show good properties, such as high strength and good processability in particular, even when the polymer concretes and casting compounds are completely free of customary fillers, such as quartz aggregates in particular. The material properties, in particular the compressive strength, are surprisingly sometimes even improved compared to the prior art.

A particular surprise is that the polymer concretes and casting compounds of the invention have improved electrical conductivity, particularly when they contain steel slag or copper slag. In addition, the thermal conductivity can sometimes be affected, more particularly reduced.

Further aspects of the invention are the subject of further independent claims. Particularly preferred embodiments of the invention are the subject of the dependent claims.

Ways of Executing the Invention

The invention provides for the use of a desiccant for influencing, more particularly increasing, the density of a curable binder composition comprising a) at least one organic binder comprising a polyisocyanate and a polyol, and b) at least 50% by weight of an inorganic filler F, more particularly in the form of quartz aggregates and/or slag, the proportions by weight being based on 100% by weight of the binder composition.

In the present case, “foaming” is understood as meaning the formation of gas bubbles in the curable binder composition through the chemical reaction of the isocyanate curing agent with freely available water during curing. The gas bubbles here can typically have a diameter in the range from micrometers to several millimeters. Foaming is in the present case associated with an expansion in volume in at least one direction in space. The foaming in % by volume represents the ratio of the volume of the foamed binder composition without desiccant to the volume of the same mass of binder composition in which foaming has been reduced by the desiccant. The aim of adding the desiccant is inter alia to control the water content in the binder composition such that binder compositions foamed in a defined manner, for example foamed polymer concretes, having a defined foam structure can be produced by foaming.

The term “desiccant” refers in the present case to substances that bind water chemically and/or physically. More particularly, the desiccant does not contain any cement. The desiccant is more particularly selected from a molecular sieve, calcium oxide, calcium chloride, sodium carbonate, potassium carbonate, calcium sulfate and/or magnesium sulfate. Preferred desiccants are a molecular sieve and/or calcium oxide. A molecular sieve is very particularly preferred.

The term “molecular sieve” stands in the present case for natural and/or synthetic zeolites. The molecular sieves are preferably aluminosilicates having a porous framework structure composed of AlO₄⁻ tetrahedra and SiO₄ tetrahedra. The pore width in the molecular sieve is more particularly 0.3-1.0 nm.

The desiccant is preferably used in the form of a solid, more preferably in powder form. A desiccant in powder form, in particular a molecular sieve, preferably has a surface area of 200-1600 m²/g, especially 500-1000 m²/g (measured by the BET method).

In the present document, “density” is, unless otherwise stated, understood as meaning the bulk density of a solid body. The bulk density is the ratio of the weight of the solid body to its volume, including the enclosed pore volume.

Curable organic binder compositions that give rise to a polyurethane after curing comprise reactively crosslinkable polyisocyanates having more than one isocyanate group per molecule, which react with polyols to afford a solid material via the formation of covalent bonds.

The curable binder composition of the invention is curable, since the isocyanate groups are still unreacted or have reacted only in part.

An “inorganic filler” is understood as meaning an inorganic particulate substance.

The filler F can be, for example, slag, quartz aggregates, sand, gravel, crushed stones, calcined pebbles, clay minerals, pumice stone, perlite, limestone, limestone powder, silica fume, chalk, titanium dioxide, baryte and/or aluminum oxide. Inorganic fillers are commercially available in different shapes and sizes. The shapes can vary from fine sand particles to large, coarse stones. The suffix “F” in the term “filler F” serves solely for better readability and distinguishability, but is no way restrictive in effect.

“Quartz aggregates” in the present context means particulate aggregates of quartz. More particularly, the quartz aggregates are quartz powder, quartz sand and/or quartz gravel. The quartz aggregates particularly preferably comprise quartz powder and/or quartz sand.

According to an advantageous embodiment, the desiccant is used in a proportion of not more than 1% by weight, more particularly 0.001-1% by weight, preferably 0.05-0.8% by weight, based on 100% by weight of the binder composition. The 100% by weight of the binder composition here includes the desiccant to be added.

The desiccant is advantageously used in a proportion of not more than 15% by weight, preferably 0.001-15% by weight, especially 0.01-14% by weight, more preferably 0.1-13% by weight, based on the total weight of the polyols and of the desiccant.

The density and/or foaming are influenced especially by selectively specifying the content of desiccant and the content of water in the curable binder composition.

In the polyurethane-based binder compositions according to the invention, these proportions permit very precise control of the density and of the foaming over wide ranges, with the mechanical properties maintained at a level relevant for practical uses.

More particularly, the proportion of desiccant is reduced to increase foaming and/or to increase the pore volume and/or to reduce the density in the cured binder composition. The increase in foaming and/or decrease in density occurs here more particularly continuously with the proportion of desiccant. If, for example, the addition of a desiccant is dispensed with, it is possible to obtain a cured binder composition in which foaming is maximized/a cured binder composition in which the density is minimized. Conversely, a desiccant proportion of 1% by weight, based on 100% by weight of the binder composition, allows foaming to be minimized and the density to be maximized.

The use of the desiccant is particularly preferably such that addition thereof in a proportion of not more than 1% by weight, more particularly 0.001-1% by weight, more particularly 0.05-0.8% by weight, based on 100% by weight of the binder composition, alters the pore volume of the cured binder composition by 0.001-40% by volume, more particularly 2-35% by volume.

In particular, the addition of the desiccant, more particularly of the molecular sieve, is executed such that addition of the desiccant in a proportion of not more than 1% by weight, more particularly 0.001-1% by weight, preferably 0.05-0.8% by weight, based on 100% by weight of the binder composition, alters the density of the cured binder composition within a range of 0.001-30% by volume, more particularly 2-26% by volume.

According to a preferred embodiment, the desiccant is used to set a density of the cured binder composition within a range of 1.7-3.9 g/cm³, more particularly 1.9-2.7 g/cm³, especially 2.0-2.5 g/cm³, the desiccant preferably being added in a proportion of not more than 1% by weight, more particularly 0.001-1% by weight, more preferably 0.05-0.8% by weight, based on 100% by weight of the binder composition.

Preference is also given to using the desiccant to produce a cured mineral binder composition having a foam structure.

A cured mineral binder composition having a foam structure is referred to in the present case also as a foamed body.

The density and/or foaming is more particularly influenced without the addition of additional liquid water. This has the advantage that the curing reaction of the organic binder is not influenced or impaired by water.

A water content in the curable binder composition is in particular not more than 0.5% by weight, for example 0.005-0.5% by weight, more particularly 0.01-0.45% by weight, especially 0.05-0.35% by weight, based on the total weight of the binder composition. This constitutes for example moisture adhering to the constituents of the curable binder composition or dissolved in the binder.

To adjust the water content, the individual constituents can be dried before use. However, it is also possible to moisten individual constituents before use and/or to add liquid water separately from the other constituents.

Use of the desiccant preferably results in pores having a pore diameter in the range of <4 mm, more particularly <1 mm, especially <0.1 mm, being produced in the cured binder composition. These are for example pores having a pore size of 10-500 μm, especially 50-200 μm, in particular 75-150 μm.

More particularly, the pores are closed-cell pores.

With regard to the pore size, it is in particular the case that at least 90%, preferably at least 95%, especially at least 100%, of all pores have a pore size/pore diameter within the specified range in each case.

The size of the pores can be determined for example by preparing microsections of the cured binder compositions and imaging them by scanning electron microscopy, in particular at 200× magnification. The pore size can then be determined from the scanning electron micrographs. In the case of pores that are not completely circular, the longest diameter is regarded as the pore diameter/pore size.

In the context of the present invention, the inorganic filler F is particularly preferably present in the form of quartz aggregates, slag or a mixture of slag and quartz aggregates.

Particularly preferably, the filler F is present in the form of slag or a mixture of slag and quartz. Very particularly preferably, the filler F is present in the form of slag.

The filler F, more particularly slag and/or quartz aggregates, preferably has a grain size/particle size of 0.1 μm to 32 mm, more particularly 0.05 to 10 mm. Particularly preferably, the filler F has a particle size of at least 0.1 mm, especially of 0.1-3.5 mm, very particularly preferably of more than 0.1 mm to 3.5 mm. The grain size/particle size can be determined by a sieving method in accordance with DIN EN 933-1.

More preferably, at least two, more particularly at least three, grain fractions having different particle sizes are present in the filler F. The at least two or three different grain fractions may consist of the same material or of different materials.

The filler F, more particularly quartz aggregates and/or slag, particularly preferably includes at least three different grain fractions. More particularly, a first grain fraction has a particle size within a range of 0.125-0.25 mm, a second grain fraction has a particle size within a range of 0.5-0.8 mm, and a third grain fraction has a particle size within a range of 2.0-3.15 mm.

More particularly, the filler F, more particularly quartz aggregates and/or slag, has a proportion of at least 60% by weight, preferably at least 65% by weight, based on 100% by weight of the binder composition.

The binder composition advantageously comprises 50% to 80% by weight, more particularly 60% to 75% by weight, especially 65% to 70% by weight, of filler F, based on 100% by weight of the binder composition. The filler F is particularly preferably quartz aggregates and/or slag, especially slag.

However, it can also be advantageous, especially for high strengths and/or good electrical conductivities, when the binder composition comprises 83% to 90% by weight, preferably 85% to 88% by weight, of filler F, based on 100% by weight of the binder composition. In this case, the filler F is likewise preferably quartz aggregates and/or slag, especially slag.

In addition to the at least 50% by weight of filler F, the binder composition preferably also comprises at least one additional filler material.

The additional filler material differs from the filler, more particularly chemically and/or in respect of particle size. Chemically different means that the filler F has an empirical formula different to that of the filler material.

A proportion of the additional filler material is preferably 10% to 40% by weight, more particularly 15% to 35% by weight, especially 20% to 30% by weight, these values being based on 100% by weight of the binder composition.

The particle size of the additional filler material is guided by the individual use and can be up to 32 mm or more. The particle size is preferably not more than 16 mm, especially preferably not more than 8 mm. The particle size is particularly preferably less than 4 mm. A particle size in the range from approximately 0.1 μm to 3.5 mm is advantageous.

More particularly, the additional filler material has a particle size of not more than 0.1 mm, preferably in the range from 0.1 μm to not more than 1 mm.

It is advantageous to mix filler materials of different particle size in accordance with the desired grading curve.

In an advantageous embodiment, the binder composition comprises filler F in the form of slag and/or quartz aggregates having a particle size of more than 0.1 mm and additional filler material having a particle size of not more than 0.1 mm and no further filler material. In this case, the additional filler material is preferably selected from quartz aggregates, sand, gravel, crushed stones, calcined pebbles, clay minerals, pumice stone, perlite, limestone, limestone powder, silica fume, chalk, titanium dioxide, baryte and/or alumina. Mixtures of two or more of the listed representatives may also be present here.

More particularly, the additional filler material is selected from the group consisting of sand, gravel, crushed stones, calcined silica, clay minerals, pumice stone, perlite, limestone, limestone powder, chalk, titanium dioxide, baryte and/or alumina. Mixtures of two or more of the listed representatives may also be present here. Particular preference is given to limestone and/or baryte.

The binder composition advantageously comprises 50% to 80% by weight, more particularly 60% to 75% by weight, especially 65% to 70% by weight, of slag and/or quartz aggregates, and also 10% to 40% by weight, more particularly 15% to 35% by weight, especially 20% to 30% by weight, of the additional filler material, these values being based on 100% by weight of the binder composition. The additional filler material includes more particularly limestone and/or baryte.

The binder composition very particularly preferably comprises 50% to 80% by weight, more particularly 60% to 75% by weight, especially 65% to 70% by weight, of slag, and also 10% to 40% by weight, more particularly 15% to 35% by weight, especially 20% to 30% by weight, of the additional filler material, more particularly limestone and/or baryte, these values being based on 100% by weight of the binder composition.

The binder composition preferably comprises filler F in the form of slag and/or quartz aggregates having a particle size of more than 0.1 mm and additional filler material that is not a slag and/or quartz aggregates and has a particle size of not more than 0.1 mm and no further filler material. Such compositions are easy to process and achieve good strength after curing.

The binder composition even more preferably comprises slag having a particle size greater than 0.1 mm and additional filler material that is not a slag and has a particle size of not more than 0.1 mm and no further filler materials.

A proportion by weight of the additional filler material in the total weight of the binder composition is preferably smaller than a proportion by weight of the filler F.

Preferably, the mass ratio of filler F, more particularly quartz aggregates and/or slag, to the additional filler material, more particularly having a particle size of not more than 0.1 mm, is from 100:0 to 60:40, more particularly from 80:20 to 70:30. Such a ratio achieves good packing of the mineral fillers and good strength in the cured binder composition. It is advantageous when the filler in this case has a particle size greater than 0.1 mm.

However, it can also be advantageous when the binder composition contains no additional filler material. The slag and/or quartz aggregates in this case preferably comprises all mineral particles having a size of approximately 0.1 μm up to 1 mm, 2 mm, 4 mm, 8 mm, or more.

It is particularly preferable when the binder composition comprises as filler F exclusively slag and no additional filler material. In this case there are also no quartz aggregates present. The slag in this case comprises all mineral particles having a size of approximately 0.1 μm up to 1 mm, 2 mm, 4 mm, 8 mm, or more. This is particularly advantageous for maximum utilization of the slag and for good strength in the cured binder composition and also, particularly in the case of iron-containing slags, for improved electrical conductivity. In addition, the thermal conductivity can sometimes also be affected.

Slag arises as a by-product of the extraction of metals in ore smelting, metal recycling or waste incineration. It is a mixture of substances that is mainly composed of oxides and silicates of various metals. The chemical composition of slags is typically stated as the oxides, irrespective of the compounds in which the elements are actually present. For example, the content of Si is stated as SiO₂, the content of Al as Al₂O₃, and the content of Fe as FeO. Thus, an analytically determined amount of 10 g of iron (Fe) corresponds for example to an amount of 12.9 g of FeO. The stated percentage for constituents in a composition of slags refers here to the percentage of the constituent as its oxide, based on the sum of all constituents in the composition, the weight of which is likewise calculated in the form of its oxides. The main constituents of slags are CaO, SiO₂, Al₂O₃, MgO, and FeO. The proportion of these substances in different types of slag can vary greatly. The composition of the slag can be determined by X-ray fluorescence analysis in accordance with DIN EN ISO 12677.

Slag, more particularly slag from metal extraction or metal recycling, is typically removed from the molten metal in the liquid state and stored to allow it to cool down, typically in slag beds. Cooling can be accelerated, for instance by spraying with water. The cooling process can influence the physical properties, in particular the crystallinity and the grain size of the slag.

Blast furnace slag (BFS) is slag that occurs during production of pig iron in a blast furnace. During the reduction process in the blast furnace, the slag forms from the other materials present alongside the iron ore and the added slag formers such as limestone or dolomite. The slag is separated from the pig iron and either allowed to cool slowly in slag beds, resulting in the formation of mainly crystalline blast furnace lump slag, or it is quickly cooled with water and/or air, resulting in the formation of glassy foundry sand (FS). Blast furnace slags typically have an iron content, calculated as FeO, of less than 3% by weight, based on the overall composition of the slag, and a bulk density of 2.1 to 2.8 kg/l.

Steel slag occurs as a by-product in steel production from pig iron or in steel recycling. Steelmaking employs a number of processes and steps that give rise to steel slag. Examples of steel slag are BOS, basic oxygen slag, which occurs as a by-product in steel production by the oxygen-blowing process, LD slag, which occurs in the Linz-Donawitz process, or EFS, electric furnace slag, also EAFS for electric arc furnace slag, which occurs during steel production or steel recycling using an electric arc furnace. Further examples of steel slag are slags that occur in other steel purification processes, such as slag from a ladle furnace (ladle slag). Steel slags typically have an iron content of about 5% to 45% by weight, calculated as FeO, based on the overall composition of the slag, and a bulk density of 3.0-3.7 kg/l.

Other processes that give rise to slags are for example metallurgical processes for the extraction of non-ferrous metals. These slags are known as metallurgical slags and often have a high iron content. One such metallurgical slag is copper slag, which occurs as a by-product of copper production. Copper slag typically has a high iron content, often of 40% by weight or more, calculated as FeO. Much of the iron in copper slags is typically in the form of iron silicate. Copper slags typically have a bulk density in the region of 3.7 kg/l.

Slags occurring in waste incineration plants or incineration plants for sewage sludge vary greatly in composition. An often characteristic feature thereof is a high iron content.

The slag is preferably selected from the group consisting of blast furnace slags, more particularly blast furnace lump slags and foundry sands, steel slags, metallurgical slags, more particularly copper slags, and slags from waste incineration, preference being given to blast furnace slags, steel slags, and metallurgical slags.

Blast furnace slags and steel slags are readily available worldwide and typically exhibit only slight variations in their chemical and mineralogical composition and physical properties from one batch to the next. Metallurgical slags, more particularly copper slag, are characterized by high density and high strength.

In a preferred embodiment of the invention, the slag is an iron-containing slag comprising at least 8% by weight, more particularly at least 10% by weight, preferably at least 15% by weight, 20% by weight or 25% by weight, of iron, calculated as FeO. More particularly, the iron-containing slag comprises 10% to 70% by weight of iron, calculated as FeO.

It has surprisingly been found that the presence in the cured binder composition of slags having a high content of iron can increase the electrical conductivity and sometimes also reduce the thermal conductivity. They are therefore especially well suited for the production of materials having improved electrical conductivity and reduced thermal conductivity. More particularly, slags in binder compositions intended to have improved electrical conductivity after curing contain 10% to 70% by weight, preferably 15% to 60% by weight, of iron, calculated as FeO. The iron-containing slag is preferably a steel slag, more particularly slag from an electric arc furnace, casting ladle, Linz-Donawitz process or oxygen blowing process, or copper slag.

In a further preferred embodiment, the slag has a bulk density of at least 2.9 kg/l, preferably at least 3.1 kg/l, more particularly at least 3.3 kg/l, especially at least 3.5 kg/l.

It has been found that binder compositions containing slags that have a high bulk density can after curing have a layer of cured binder on the upper side (upper surface) in which the proportion of slag is significantly lower than in the rest of the cured binder composition. More particularly, the proportion of slag having a particle size above 0.1 mm is in this layer less than 10% by weight, more particularly less than 5% by weight. This results in particularly good adhesion to an overlying material, which is especially advantageous, for example, for anchoring machines and turbines by grouting.

The preferred particle size of the slag is guided by the individual use and can be up to 32 mm or more. The slag advantageously has a particle size of not more than 16 mm, preferably not more than 8 mm, more preferably not more than 4 mm, especially not more than 3.5 mm.

Slag particles of suitable size can also be obtained by crushing and/or grinding larger slag particles.

The slag can be separated into grain size fractions, for example by sieving, after which the individual grain size fractions can be mixed in different amounts so as to obtain a desired grain-size distribution, the grading curve. Such methods are known to the person skilled in the art.

The slag advantageously has a particle size of 0.05 to 16 mm, preferably 0.06 to 8 mm, more preferably 0.1 to 4 mm, especially 0.12 to 3.5 mm.

The slag particles preferably are irregularly shaped and/or have a rough surface and more particularly are nonspherical. This is advantageous in particular for interlinking the particles with one another and for a good bond with the binder.

More particularly, the slag particles may—uniformly or non-uniformly—have any nonspherical geometric shape. For example, the particles may be conical, polygonal, cubic, pentagonal, hexagonal, octagonal, prismatic and/or polyhedral in shape. Non-uniform particles may for example have circular, elliptical, oval, square, rectangular, triangular or polygonal cross sections present at least partially therein. The terms “non-uniformly” or “irregularly” shaped particles refer to three-dimensional particle shapes in which at least two different cross sections through the particles have a different shape. Examples of cross sections through irregularly shaped slag particles are shown schematically in FIG. 1.

Preference is given to a slag, more particularly a steel slag, that has been cooled with water, particularly in slag beds. Also advantageous is a slag, more particularly a copper slag, that has been granulated as a slag stream with a pressurized-water jet.

The more rapid cooling breaks the slag into small pieces. This is advantageous because it can save energy in comminution and also because it gives rise to irregular, often angular shapes.

The moisture content of the slag is preferably less than 5% by weight, more preferably less than 3% by weight, especially preferably less than 1% by weight, more particularly less than 0.5% by weight.

For certain uses it can be advantageous when the porosity of the slag is in the region of 5% by volume. This allows the weight of the product to be reduced without major adverse effect on the end properties.

For certain uses it can also be advantageous when the porosity of the slag is above 5% by volume, thereby allowing the weight of the product to be reduced. For certain uses, especially for highly pressure-resistant materials, it can also be advantageous when the porosity of the slag is less than 5% by volume, preferably less than 3% by volume.

In a particularly advantageous embodiment of the invention, the binder composition is preferably largely free of quartz aggregates, more particularly of quartz sand and quartz powder. More particularly, it comprises less than 10% by weight, preferably less than 5% by weight, more preferably less than 1% by weight, of quartz aggregates. Such a composition conserves natural resources and permits good to very good processing properties, curing properties, and use properties.

The organic binder in the curable binder composition comprises at least one polyisocyanate and at least one polyol.

Polyisocyanate is understood as meaning a compound that contains two or more isocyanate groups. The term polyisocyanate here also encompasses polymers containing isocyanate groups. Polyisocyanates give rise to polyurethanes through a reaction with atmospheric moisture or with polyols. The term “polyurethane” here refers to polymers formed by what is known as diisocyanate polyaddition. In addition to the urethane groups, these polymers can also have other groups, more particularly urea groups.

Preferred polyisocyanates are aliphatic, cycloaliphatic or aromatic diisocyanates, more particularly hexamethylene 1,6-diisocyanate (HDI), 1-isocyanato-3,3,5-trimethyl-5-isocyanatomethylcyclohexane (isophorone diisocyanate or IPDI), perhydrodiphenylmethane 2,4′- and/or 4,4′-diisocyanate (H₁₂MDI), diphenylmethane 4,4′-diisocyanate, with or without fractions of diphenylmethane 2,4′- and/or 2,2′-diisocyanate (MDI), tolylene 2,4-diisocyanate or mixtures thereof with tolylene 2,6-diisocyanate (TDI), mixtures of MDI and MDI homologs (polymeric MDI or PMDI), mixtures of MDI and MDI derivatives, more particularly MDI carbodiimides, or oligomeric isocyanates.

A suitable polymer containing isocyanate groups is more particularly obtained from the reaction of at least one polyol with a superstoichiometric amount of at least one polyisocyanate, more particularly a diisocyanate, preferably MDI, TDI, IPDI or HDI. Preferred polymers containing isocyanate groups are what are known as quasi-prepolymers, which are obtained from the reaction of at least one polyol with a greatly superstoichiometric amount of at least one polyisocyanate, more particularly a diisocyanate or mixtures thereof with homologs or derivatives thereof, and are mixtures of diisocyanates, with or without homologs or derivatives thereof, and adducts thereof with polyols.

Particularly preferred polyisocyanates are aromatic polyisocyanates, more particularly diphenylmethane 4,4′-diisocyanate, with or without proportions of diphenylmethane 2,4′- and/or 2,2′-diisocyanate (MDI), mixtures of MDI and MDI homologs (polymeric MDI or PMDI), mixtures of MDI and MDI derivatives, more particularly MDI carbodiimides, and mixtures of MDI, with or without homologs or derivatives, and adducts thereof with polyols.

Suitable polyols are more particularly the following commercially available polyols or mixtures thereof:
polyether polyols, more particularly polyoxyalkylene diols and/or polyoxyalkylene triols. Preferred polyether polyols are polyoxypropylene diols, polyoxypropylene triols or ethylene oxide-terminated (EO-endcapped) polyoxypropylene diols or -triols.
polyester polyols, also called oligoesterols, prepared by known processes, more particularly the polycondensation of hydroxycarboxylic acids or lactones or the polycondensation of aliphatic and/or aromatic polycarboxylic acids with di- or polyhydric alcohols. Particularly suitable polyester polyols are polyester diols.
polycarbonate polyols as obtainable by reaction for example of the abovementioned alcohols—used to form the polyester polyols—with dialkyl carbonates, diaryl carbonates or phosgene.
block copolymers bearing at least two hydroxyl groups and having at least two different blocks having polyether, polyester and/or polycarbonate structure of the type described above, more particularly polyether polyester polyols.
polyacrylate polyols and polymethacrylate polyols,
polyhydroxy-functional fats and oils, also called fatty acid polyols,
polyhydrocarbon polyols, also called oligohydrocarbonols,
epoxidized vegetable oils and reaction products thereof with monofunctional alcohols,
polybutadiene polyols,
reaction products of vegetable oils, more particularly castor oil, with ketone resins,
polyester polyols based on hydrogenated tall oil,
polyester polyols based on dimer fatty acids or dimer fatty alcohols,
alkoxylated polyamines.

The organic binder preferably includes at least a mixture of polyols having different OH functionality.

The binder composition preferably comprises at least one aromatic polyisocyanate and at least one polyol selected from the group consisting of epoxidized vegetable oils and reaction products thereof with monofunctional alcohols, polybutadiene polyols, reaction products of vegetable oils, more particularly castor oil, with ketone resins, polyester polyols based on hydrogenated tall oil, and polyester polyols based on dimer fatty acids or dimer fatty alcohols.

Especially advantageous are combinations of polyisocyanates and polyols as described in EP 3 339 343 and EP 3 415 544.

Such binder compositions are particularly hydrophobic, do not absorb moisture after curing, and are stable to hydrolysis, which is advantageous.

Suitable catalysts are metalorganic compounds or amines, more particularly secondary and tertiary amines.

Preferably present in the binder composition is at least one wetting agent and/or dispersant, more particularly one based on a polycarboxylate ether. This affords better processability, in particular good flowability, and a high proportion of fillers, which is advantageous for good homogeneity and strength in the cured binder composition.

In this document, polycarboxylate ether is understood as meaning a comb polymer in which anionic groups as well as polyalkylene glycol side chains are covalently attached to the polymer backbone. Such polymers are known as plasticizers for mineral binders such as cement and gypsum.

Preferred polycarboxylate ethers include structural units of the formula I and structural units of the formula II,

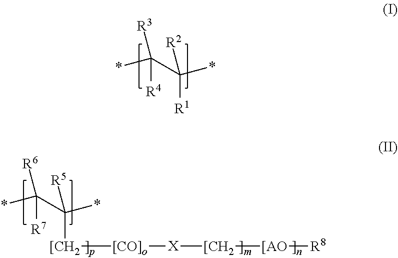

where
R¹ is in each case independently —COOM, —SO₂-OM, —O—PO(OM)₂ and/or —PO(OM)₂, preferably —COOM,
R² and R⁵ are in each case independently H, —CH₂—COOM or an alkyl group having 1 to 5 carbon atoms, preferably H or —CH₃,
R³ and R⁶ are in each case independently H or an alkyl group having 1 to 5 carbon atoms, preferably H,
R⁴ and R⁷ are in each case independently H, —COOM or an alkyl group having 1 to 5 carbon atoms, preferably H,
or where R¹ and R⁴ form a ring to give —CO—O—CO— (anhydride),
M is in each case independently H⁺, an alkali metal ion, an alkaline earth metal ion, a di- or trivalent metal ion, an ammonium group or an organic ammonium, preferably H⁺ or an alkali metal ion,
p=0, 1 or 2,
o=0 or 1,
m=0, or an integer from 1 to 4,
n=2-250, more particularly 10-200,
X is in each case independently —O— or —NH—,
R⁸ is in each case independently H, a C₁ to C₂₀ alkyl group, cyclohexyl group or alkylaryl group, and
A=C₂ to C₄ alkylene, preferably ethylene.

The molar ratio of structural unit I to structural unit II is preferably 0.7-10:1, more preferably 1-8:1, more particularly 1.5-5:1.

It can also be advantageous when the polycarboxylate ether further comprises a structural unit III. Structural unit III is preferably derived from monomers selected from the group consisting of alkyl or hydroxyalkyl esters of acrylic or methacrylic acid, vinyl acetate, styrene and N-vinylpyrrolidone.

The polycarboxylate ether preferably contains carboxylic acid groups and/or salts thereof and polyethylene glycol side chains.

Preferably, the polycarboxylate ether is composed of structural units I derived from ethylenically unsaturated carboxylic acids, more particularly unsaturated monocarboxylic acids, or salts thereof, and structural units II derived from ethylenically unsaturated polyalkylene glycols, more particularly polyethylene glycols. More particularly, the polycarboxylate ether does not contain any other structural units aside from structural units I and structural units II.

The filler, more particularly quartz aggregates and/or slag, and optionally also the additional filler material, if present, are preferably coated with the wetting agent and/or dispersant. Coating can be accomplished by simply spraying either with a liquid wetting agent and/or dispersant or with a solution of a liquid or solid wetting agent and/or dispersant in a suitable solvent.

The polyisocyanate and the polyol preferably together have a proportion, based on 100% by weight of the binder composition, of at least 5% by weight, preferably at least 10% by weight, more particularly 8% to 22% by weight, especially 10% to 15% by weight.

As mentioned above, the desiccant is in a particular embodiment used in the production of a cured mineral binder composition having a foam structure.

The invention accordingly also provides for the use of a desiccant to influence the density and/or the foaming of a curable binder composition in the production of a cured mineral binder composition having a foam structure. In this case, the curable binder composition, subsequent to use according to the invention, is cured to afford a cured binder composition having a foam structure.

More particularly, the invention relates also to the use of a desiccant for producing a cured mineral binder composition having a foam structure, the cured mineral binder composition having a foam structure being produced from a curable binder composition comprising a) at least one organic binder comprising a polyisocyanate and a polyol, and b) at least 50% by weight of an inorganic filler F, more particularly in the form of quartz aggregates and/or slag, the proportions by weight being based on 100% by weight of the binder composition, and the desiccant being used for influencing the density and/or the foaming of the curable binder composition.

More particularly, the desiccant is used to increase the density and/or to reduce foaming.

The desiccant can for this purpose be added during production of the curable binder composition, preferably in a proportion of not more than 1% by weight, more particularly 0.001-1% by weight, more preferably 0.05-0.8% by weight, based on 100% by weight of the binder composition.

The curable binder composition preferably also contains water, more particularly in a proportion of not more than 0.5% by weight, for example 0.005-0.5% by weight, more particularly 0.01-0.45% by weight, especially 0.05-0.35% by weight, based on the total weight of the binder composition.

More particularly, both the desiccant content described above and the water content described above are realized.

According to a preferred embodiment, the desiccant content and/or the water content are chosen such that this results in a cured binder composition having a foam structure.

The combination of water and desiccant allows a defined foam structure to be obtained. The simultaneous presence of water and desiccant in the amounts mentioned above results here in a foam structure in the cured binder that has a particularly fine-pored and homogeneous structure. If the desiccant is omitted and the water content is instead reduced to increase the density, a less fine-pored and less homogeneous structure is obtained. This points to an unusual functional interaction of water and desiccant in respect of structure formation.

According to a preferred embodiment, the desiccant content and/or the water content are chosen such that this results in a cured binder composition having a foam structure with a density within a range of 1.7-3.9 g/cm³, more particularly 1.9-2.7 g/cm³, especially 2.0-2.5 g/cm³.

According to a preferred embodiment, the desiccant content and/or the water content are chosen such that this results in a cured binder composition having a foam structure with a volume and/or pore volume that is 0.1-40% by volume, more particularly 1-40% by volume, more particularly 2-35%, greater than that of a cured binder composition produced on the basis of a completely water-free but otherwise identical curable binder composition.

The cured mineral binder composition having a foam structure more particularly has pores having a pore diameter in the range of <4 mm, more particularly <1 mm, especially <0.1 mm. These are for example pores having a pore size of 10-500 μm, especially 50-200 μm, in particular 75-150 μm.

Advantageous curable binder compositions for the uses according to the invention will be apparent from the executions hereinabove and hereinbelow. For producing a cured mineral binder composition having a foam structure, very particular preference is given to curable mineral binder compositions comprising:
3% to 40% by weight of polyisocyanates,
3% to 40% by weight of polyols,
50% to 93.999% by weight of filler F, more particularly slag and/or quartz aggregates, preferably at least 20% by weight of the filler F being iron-containing slag,
0.001-1% by weight, more particularly 0.05-0.8% by weight of desiccant, more particularly molecular sieve and/or calcium oxide,
optionally 10% to 40% by weight, more particularly 15% to 35% by weight, especially 20% to 30% by weight, of additional filler material, more particularly limestone and/or baryte,
0% to 15% by weight of further additives, and
water in a maximum proportion of 0.5% by weight, for example 0.005-0.5% by weight, more particularly 0.01-0.45% by weight, especially 0.05-0.35% by weight,
   based on 100% by weight of the binder composition.

Curable binder compositions comprising the desiccant and water have in addition been found to have a surprisingly low tendency to shrinkage. Shrinkage refers to the reduction in volume over time, which typically occurs as a result of structural changes during curing.

The desiccant can therefore be used in combination with water, more particularly in the amounts mentioned above, to reduce the shrinkage of binder compositions having a foam structure.

A further aspect of the present invention relates to a curable binder composition comprising: a) at least one organic binder comprising a polyisocyanate and a polyol, b) at least 50% by weight of an inorganic filler F, more particularly quartz aggregates and/or slag, and c) a desiccant, the proportions by weight being based on 100% by weight of the binder composition.

According to an advantageous embodiment, the desiccant is used in a proportion of not more than 1% by weight, more particularly 0.001-1% by weight, more preferably 0.05-0.8% by weight, based on 100% by weight of the binder composition.

The desiccant is advantageously used in a proportion of not more than 15% by weight, preferably 0.001-15% by weight, especially 0.01-14% by weight, more preferably 0.1-13% by weight, based on the total weight of the polyols and of the desiccant together.

The organic binder, the polyol, the polyisocyanate, and the filler F and any further constituents present are preferably selected in accordance with their use as described hereinabove.

An advantageous binder composition comprises:
3% to 40% by weight of polyisocyanates,
3% to 40% by weight of polyols,
50% to 93.999% by weight of filler F, more particularly slag and/or quartz aggregates, preferably at least 20% by weight of the filler F being iron-containing slag,
0.001-1% by weight, more particularly 0.05-0.8% by weight of desiccant, more particularly molecular sieve and/or calcium oxide,
optionally 10% to 40% by weight, more particularly 15% to 35% by weight, especially 20% to 30% by weight, of additional filler material, more particularly limestone and/or baryte,
0% to 15% by weight of further additives, and
0% to 0.5% by weight of water,
   based on 100% by weight of the binder composition.

Especially suitable for the production of mineral binder compositions having a foam structure are curable mineral binder compositions comprising:
3% to 40% by weight of polyisocyanates,
3% to 40% by weight of polyols,
50% to 93.999% by weight of filler F, more particularly slag and/or quartz aggregates, preferably at least 20% by weight of the filler F being iron-containing slag,
0.001-1% by weight, more particularly 0.05-0.8% by weight of desiccant, more particularly molecular sieve and/or calcium oxide,
optionally 10% to 40% by weight, more particularly 15% to 35% by weight, especially 20% to 30% by weight, of additional filler material, more particularly limestone and/or baryte,
0% to 15% by weight of further additives, and
water in a maximum proportion of 0.5% by weight, for example 0.005-0.5% by weight, more particularly 0.01-0.45% by weight, especially 0.05-0.35% by weight,
   based on 100% by weight of the binder composition.

Preferably, the binder compositions of the invention prior to use take the form of a multicomponent system, more particularly of a system having two or three components. The constituents capable of reacting with one another in a curing reaction are preferably present in containers stored separately from one another. In this form, the binder composition can be stored for a period of several months up to a year and longer without any alteration in its properties to an extent relevant to its use. Only when the binder composition is used are the reactive components of the organic binder mixed with one another, whereupon curing of the binder composition commences.

The invention further provides a multicomponent system for producing a curable binder composition comprising at least one polyisocyanate component comprising at least one polyisocyanate, and at least one polyol component comprising at least one polyol, wherein the filler F, the desiccant, and optionally further ingredients are present in the polyisocyanate component, in the polyol component and/or in a further component, a solid component.

The desiccant is more preferably present in the polyol component. More particularly, the desiccant has a proportion in the polyol component of 0.01-15% by weight, more particularly 0.1-13% by weight, based on the total weight of the polyols and of the desiccant together.

The weight ratio of the polyisocyanate component to the polyol composition is preferably in the range from 2:1 to 1:3, more preferably from 1:1 to 1:2.

The weight ratio of polyisocyanate component plus polyol component to the solid component is preferably 1:3 to 1:12, more particularly 1:4 to 1:10.

The multicomponent system preferably comprises a solid component comprising the filler F, more preferably slag. The solid component preferably comprises at least 60% by weight, preferably at least 70% by weight, especially at least 80% by weight or at least 90% by weight, advantageously even 100% by weight, of slag and/or quartz aggregates, more particularly slag.

In addition to slag and/or quartz aggregates, the solid component preferably comprises the optional additional filler material, the optional wetting agent and/or dispersant, and optionally further additives.

A preferred composition of the solid component comprises:
70% to 90% by weight of slag and/or quartz aggregates, preferably slag, more particularly having a particle size of 0.1 to 16 mm, preferably 0.11 to 8 mm, more particularly 0.12 to 4 mm,
10% to 30% by weight of additional filler material, more particularly having a particle size of not more than 0.1 mm, more particularly about 0.1 μm to 0.1 mm,
0% to 2% by weight, more particularly 0.01% to 1.5% by weight, of additives comprising at least one wetting agent or dispersant, more particularly a polycarboxylate ether, and
0% to 5% by weight of an organic solvent, more particularly a solvent in which the polycarboxylate ether is soluble.

A further preferred composition of the solid component comprises:
93% to 100% by weight, preferably 95% to 99.97% by weight, of slag and/or quartz aggregates, preferably slag, more particularly having a particle size of about 0.1 μm to 16 mm, preferably about 0.1 μm to 8 mm, more particularly about 0.1 μm to 4 mm,
0% to 1.5% by weight, preferably 0.01% to 1% by weight, of a polycarboxylate ether, and
0% to 5% by weight, preferably 0.02% to 4% by weight, of an organic solvent in which the polycarboxylate ether is soluble.

The invention further provides for the use of the binder composition or of the multicomponent system for the bonding, coating or sealing of substrates, for the filling of edges, holes or joints, as anchoring or injection resin, as a grouting or casting compound, as a floor covering and/or for production of moldings.

The invention further relates to the use of the binder composition, or of the multicomponent system, for the production of polymer concretes and/or casting compounds that have improved resistance to corrosion by corrosive substances, more particularly acidic and/or basic aqueous solutions. The corrosion resistance is preferably improved in respect of acidic, neutral, and also basic aqueous solutions.

An acidic solution is here understood as meaning more particularly a solution having a pH of <7, preferably of <4. A basic solution means in particular a solution having a pH of >7, preferably of >10.

“Improved corrosion resistance” is understood here more particularly as meaning that the compressive strength of the polymer concrete or of the casting compound after curing for 7 days at 20° C., followed by storage at 20° C. for 21 days in an aqueous 10% by volume solution of acetic acid, a neutral aqueous solution and/or an aqueous 50% by weight solution of NaOH and subsequent drying to constant weight, decreases by less than 10%, more particularly less than 5%, preferably less than 1%. The compressive strength is preferably determined in accordance with the ASTM D695 standard.

The filler F in the binder composition or in the multicomponent system is preferably slag, more particularly iron-containing slag.

A proportion of slag is here more particularly at least 60% by weight, preferably at least 65% by weight, based on 100% by weight of the binder composition.

The binder composition even more preferably comprises slag having a particle size greater than 0.1 mm and additional filler material that is not a slag and has a particle size of not more than 0.1 mm and no further filler materials.

The binder composition or the multicomponent system are therefore particularly suitable for uses in which they come into contact with corrosive substances, more particularly acidic and/or basic aqueous solutions.

Another aspect of the invention therefore relates to the use of the binder composition, or of the multicomponent system, for uses in which the binder composition, or the multicomponent system, after curing comes into contact with corrosive substances, more particularly acidic and/or basic aqueous solutions.

These are preferably uses in which the binder composition, or the multicomponent system, after curing comes into contact with both acidic and basic aqueous solutions.

Another aspect of the present invention relates to the use of the cured binder composition, or of a cured multicomponent system, for conducting electric current, in particular for dissipating electrostatic charges and/or for balancing the electric potential between two bodies.

The invention further provides for the use of the binder composition of the invention, or of the multicomponent system of the invention, for the production of materials having improved electrical conductivity at 20° C., characterized in that the slag in the binder composition is an iron-containing slag comprising at least 8% by weight of iron, calculated as FeO, based on the total weight of the slag, and/or a slag having a bulk density of at least 3.1 kg/I.

A cured binder composition of this kind surprisingly shows improved electrical conductivity compared to a cured binder composition that, instead of the iron-containing slag, comprises the same amount by weight of quartz aggregates having the same grading curve.

The material with improved electrical conductivity preferably has a specific electrical volume resistance that is reduced by a factor of at least 2, more preferably at least 2.5, more particularly at least 3.0, compared to an material that is otherwise identical except for containing quartz aggregates of the same particle size instead of the iron-containing slag. The electrical volume resistance is determined between the two opposite 40×40 mm surfaces of a prism of 40×40×160 mm by applying a voltage of 100 mV and a frequency of 1 kHz at 20° C., the measurement being performed after storage for 7 days at 20° C.

The invention also provides for the use of a curable binder composition of the invention for the production of a thermally insulating material. By using slag instead of quartz aggregates, the thermal conductivity can be reduced.

Curable binder compositions comprising slags having a bulk density of at least 2.9 kg/I, more particularly at least 3.1 kg/I, preferably at least 3.3 kg/I, especially at least 3.5 kg/I, are particularly advantageous for the grouting of machines. This makes it possible to obtain an especially good bond between the cured binder composition and the overlying machine or turbine that has been grouted, as well as good compressive strength in the grouting material.

The multicomponent system is used by mixing the components. This is advantageously done by first thoroughly mixing the at least two components comprising the constituents of the organic binder and then thoroughly mixing in the component comprising the filler F, more particularly slag, if there is such a separate component. Further components or additives may also be added. Once all the components have been mixed, curing takes place. Such processing is known to the person skilled in the art.

The freshly mixed curable binder composition can surprisingly be processed very easily and homogeneously at ambient temperatures despite the high proportion of filler F, more particularly slag.

It can also be advantageous, in particular for use of the binder composition of the invention as leveling mortar, screed or floor coating, when a binder composition of the invention is mixed and applied in the following steps:
mixing all the components of the binder composition, except for fillers having a particle size greater than 0.06 mm, using suitable mixing devices,
applying the mixture as leveling mortar, screed or floor coating, and
sprinkling with fillers having a particle size greater than 0.06 mm, wherein at least 20% by weight of these fillers is iron-containing slag, manually or using a suitable device.

The invention further provides a cured binder composition, more particularly a cured binder composition having a foam structure, obtained by curing the curable binder composition of the invention or by mixing the components and curing the multicomponent system of the invention.

Curing preferably takes place at ambient temperatures, more particularly at a temperature in the range from 5 to 40° C., preferably 7 to 35° C.

The binder composition is cured when there are no longer any significant reactions between isocyanate groups and the hydroxyl groups of the polyol. The cured binder composition has a solid consistency. More particularly, it can be in the form of a three-dimensional object or component, or of a coating, bonding layer, spackling compound, constituent of a laminate, adhesive, filling or seal.

Preferably, the cured binder composition has a porous structure or the cured binder composition is present in the form of a foamed body. In particular, the pores have a maximum pore size of <4 mm, more particularly <1 mm, especially less than 0.1 mm. These are for example pores having a pore size of 10-500 μm, especially 50-200 μm, in particular 75-150 μm. These are preferably closed-cell pores.

The density of the cured binder composition is within a range of preferably 1.7-3.9 g/cm³, more particularly 1.9-2.7 g/cm³, especially 2.0-2.5 g/cm³.

More particularly, the cured binder composition has a pore volume of 0.1-40% by volume, more particularly 1-40% by volume, more particularly 2-35% by volume.

Specifically, the density of the cured binder composition is greater than the density of a cured binder composition that does not contain any desiccant but is otherwise of the same composition.

The filler F, more particularly quartz aggregates and/or slag, and the filler material, if present, are preferably dispersed uniformly or largely uniformly in the cured binder composition.

However, it can also be advantageous, in particular for underfilling, for example of machines and turbines, when the concentration of filler F, more particularly slag, in the topmost layer of the horizontal surface of the cured binder composition is lower than in the rest of the cured binder composition, more particularly less than 10% by weight. This can improve the bond between the binder composition and the object to be underfilled.

### BRIEF DESCRIPTION OF THE FIGURES

FIG. 1 shows: a schematic representation of exemplary cross sections of irregularly shaped slag particles,

FIG. 2 shows: the compressive strengths of inventive test specimens having a polyurethane matrix and different fillers after storage in different media (H₂O, AcOH or NaOH);

FIG. 3 shows: the compressive strengths of further inventive test specimens having a polyurethane matrix and different fillers after storage in different media;

FIG. 4 shows: the compressive strengths of epoxy resin-based test specimens having different fillers after storage in different media;

FIG. 5 shows: cured test specimens of polyurethane-based grouting mortar that had been foamed in a controlled manner using varying amounts of desiccant;

FIG. 6 shows: on the left-hand side a cross section through a strongly foamed polyurethane-based grouting mortar sample and on the right-hand side a cross section through an unfoamed sample containing air bubbles;

FIGS. 7a-e show: scanning electron micrographs of cured samples of polyurethane matrix E having varying porosity;

FIGS. 8a-e show: scanning electron micrographs of cured samples of polyurethane matrix E and 89% by weight of quartz sand containing varying proportions of molecular sieve.

### EXAMPLES

Working examples are presented hereinbelow, the purpose of which is to further elucidate the described invention. The invention is of course not limited to these described working examples.

“Ex.” stands for “example”.

“Ref.” stands for “reference example”.

Materials Used

Setathane® 1150 is a polyol based on a reaction product of castor oil with ketone resins (Alinex Resins Germany GmbH, Germany).

Desmophen® T4011 is a polyether polyol based on 1,1,1-trimethylolpropane (Covestro AG, Germany).

Sylosiv® is a zeolite-based molecular sieve powder having a pore diameter of 3-5 Å and a surface area of approx. 800 m²/g (W.R. Grace & Co., USA)

Desmodur® VL is an aromatic polyisocyanate based on diphenylmethane diisocyanate (Covestro AG, Germany)

Desmodur® CD-L is an aromatic polyisocyanate based on 4,4′-diphenylmethane diisocyanate (Covestro AG, Germany)

Neukapol® 1119 is a reaction product of epoxidized vegetable oils (rapeseed oil) having a proportion of unsaturated C18 fatty acids of 91% by weight, based on the total amount of fatty acids, with monofunctional C₁ to C₈ alcohols; OH functionality 2.0, average molecular weight approx. 390 g/mol, OH value of 290 mg KOH/g (Altropol Kunststoff GmbH, Germany).

Neukapol® 1582 is a reaction product of epoxidized fatty acid methyl esters with glycerol, where the epoxidized fatty acid methyl esters, as fatty acid component, are based on fatty acid mixtures of rapeseed oil or sunflower oil, in a mixture with N,N,N′,N′-tetrakis(2-hydroxypropyl)ethylenediamine (Altropol Kunststoff GmbH, Germany).

The quartz sand and slags were dried before use and divided into grain fractions by sieving. The grain fractions were then mixed such that the grain size distribution of the sands used corresponded to a specified grain size distribution (grading curve).

EFS is an electric furnace slag from Stahl Gerlafingen AG, Switzerland. The material used had a bulk density of around 3.3 kg/l and an iron content, calculated as FeO, of about 19% by weight.

BFS is a blast furnace slag from Hüttenwerke Krupp Mannesmann, Germany, available from Hermann Rauen GmbH & Co., Germany. The material used had a bulk density of 2.9 kg/l and an iron content, calculated as FeO, of about 3% by weight.

Raulit® is a blast furnace slag from DK-Recycling und Roheisen GmbH, Germany, available under the brand name Raulit®-Mineralbaustoffgemisch from Hermann Rauen GmbH & Co., Germany. The material used had a bulk density of around 2.9 kg/l and an iron content, calculated as FeO, of about 1% by weight.

FS is a foundry sand from voestalpine AG, Austria. The material used had a bulk density of around 2.9 kg/l and an iron content, calculated as FeO, of less than 1% by weight.

CS is NAstra® iron silicate granules, a glassy copper slag available from Sibelco Deutschland GmbH, having a bulk density of about 3.7 kg/l and an iron content, calculated as FeO, of about 51% by weight.

Sikadur®-42 HE is a three-component epoxy-resin-based grouting mortar available from Sika Schweiz AG.

The polycarboxylate ether is a comb polymer with carboxylic acid groups and polyethylene glycol side chains, Sika Viscocrete® 430P available from Sika Schweiz AG.

Measurement Methods

Compressive strength and flexural strength were determined on 40×40×160 mm test specimens using testing machines in accordance with DIN EN 196-1 and EN 12190.

For determination of the specific electrical volume resistance, the opposite 40×40 mm surfaces of the 40×40×160 mm test specimens were coated with electrically conductive gel and a steel electrode covering the entire surface was laid flush on both surfaces. The electrical volume resistance of the test specimens was determined by applying a voltage of 100 mV AC at a frequency of 1 kHz and 10 kHz to the two electrodes.

Thermal conductivity was determined in accordance with ASTM D5470-06 using the ZFW TIM tester from ZFW (Center for Thermal Management) Stuttgart, Germany, on test specimens 30 mm in diameter and 2 mm in height.

Polyurethane Matrix

For the examples, the polyol components (component A) and polyisocyanate components (component B) described in Tables 1 and 2 were used as the polyurethane matrix.

For each composition, the ingredients specified in Tables 1 and 2 were processed in the specified amounts (in parts by weight) of the polyol component A, by means of a vacuum dissolver with exclusion of moisture, to give a homogeneous paste and stored. The ingredients of the polyisocyanate component B specified in Tables 1 and 2 were likewise stored.

TABLE 1
Compositions of the polyurethane matrices (all figures except ratios in % by weight)

| | A | B | C | D | E | F |
|---|---|---|---|---|---|---|
| Component A | | | | | | |
| Setathane ® 1150 | 65.6 | 65.6 | 59.7 | 59.7 | 55.3 | 55.3 |
| Desmophen ® T4011 | 4.3 | 4.3 | 3.7 | 3.7 | 3.5 | 3.5 |
| Hydroxy-terminated | 19.0 | 19.0 | 18.7 | 18.7 | 17.3 | 17.3 |
| polybutadiene polyol | | | | | | |
| Chain extender | | | | | | |
| Butane-1,4-diol | 4.3 | 4.3 | — | — | — | — |
| Pentane-1,5-diol | — | — | 11.2 | 11.2 | — | — |
| Ethylhexane-1,3-diol | — | — | — | — | 13.8 | 13.8 |
| Sylosiv ® | 6.9 | 6.9 | 6.6 | 6.6 | 10.0 | 10.0 |
| Process chemicals¹⁾ | 0.1 | 0.1 | 0.1 | 0.1 | 0.1 | 0.1 |
| Component B | | | | | | |
| Desmodur ® VL⁶⁾ | 100 | — | 100 | — | 100 | — |
| Desmodur ® CD-L⁷⁾ | — | 100 | — | 100 | — | 100 |
| Mixing ratio A:B | 100:49.4 | 100:52.9 | 100:65.1 | 100:69.7 | 100:57.5 | 100:61.6 |
| [wt %/wt %] | | | | | | |
| NCO:OH | 1.11 | 1.11 | 1.11 | 1.11 | 1.10 | 1.10 |

¹⁾Defoamer and catalyst

TABLE 2
Compositions of the polyurethane matrices
(all figures except ratios in % by weight)

| | G | H | I | J |
|---|---|---|---|---|
| Component A | | | | |
| Neukapol ® 1119 | 43.9 | 43.9 | 58.0 | 58.0 |
| Neukapol ® 1582 | 22.0 | 22.0 | 29.0 | 29.0 |
| Hydroxy-terminated | 22.0 | 22.0 | — | — |
| polybutadiene polyol | | | | |
| Sylosiv ® | 12.0 | 12.0 | 12.8 | 12.8 |
| Process chemicals¹⁾ | 0.1 | 0.1 | 0.1 | 0.1 |
| Component B | | | | |
| Desmodur ® VL | 100 | — | 100 | — |
| Desmodur ® CD-L | — | 100 | — | 100 |
| Mixing ratio A:B | 100:64.6 | 100:69.2 | 100:81.9 | 100:87.8 |
| [wt %/wt %] | | | | |
| NCO:OH | 1.07 | 1.07 | 1.07 | 1.07 |

¹⁾Defoamer and catalyst

Solid Component

For production of the solid component, the solid constituents listed in Table 3 were mixed dry, during which a polycarboxylate ether solution was applied by spraying.

TABLE 3
Composition of the solid component

| | Proportion |
|---|---|
| Constituent | [wt %] |
| Mixture of limestone powder and baryte | 25.2 |
| powder, <0.1 mm | |
| Sand (slag sand or quartz sand)*, 0.12-3.2 mm | 74.3 |
| Polycarboxylate ether solution (20% by weight of | 0.5 |
| polycarboxylate ether dissolved in 80% by weight of | |
| benzyl alcohol) | |

*Sand type: See examples.

Production of Curable Grouting Mortars and Test Specimens

The polyol components A and polyisocyanate components B from Tables 1 and 2 were processed into a homogeneous paste for 30 seconds using a SpeedMixer® (DAC 150 FV, Hauschild; for mixing ratios see Tables 1 and 2). A solid component as per Table 3 was then added and mixed in thoroughly. Unless otherwise stated, the solid component had a constant proportion of 89.5% by weight, while the mixed polyol components A and polyisocyanate components B together had a proportion of 10.5% by weight.

For comparison purposes, curable compositions and test specimens based on an epoxy resin matrix (hereinafter referred to as SD) were produced as follows: Sikadur®-42 HE component A (comprising the epoxy resin) was mixed thoroughly with the associated component B (comprising the curing agent) in a weight ratio of 3:1 and then a self-produced solid component as per Table 3 was added and mixed in thoroughly. Unless otherwise stated, the solid component had a constant proportion of 89.5% by weight, while the mixed epoxy resin and curable components together had a proportion of 10.5% by weight.

To produce the test specimens, the mixed curable compositions were poured into steel molds and stored in the formwork for 24 hours at 20° C. The test specimens were then removed from the formwork and stored further at 20° C. After 7 days of storage, the specific electrical resistance, strength, and thermal conductivity were determined.

Strength and Electrical Volume Resistance of Grouting Mortars

The strengths and electrical volume resistance of various grouting mortars are reported in the tables below.

The “Binder matrix” row indicates the polyurethane matrix/epoxy resin matrix used (see Tables 1 and 2), while the “Sand” row indicates the type of sand or slag used in the solid component (see Table 3).

TABLE 4
Results when using quartz sand and Desmodur ® VL as
polyisocyanate component in the polyurethane matrix

| | Ref. 1 | B1 | B2 | B3 | B4 | B5 |
|---|---|---|---|---|---|---|
| Binder matrix | SD | I | G | E | C | A |
| Sand | Quartz | Quartz | Quartz | Quartz | Quartz | Quartz |
| | sand | sand | sand | sand | sand | sand |
| Compressive | 104 | 99 | 71 | 74 | 82 | 64 |
| strength [MPa] | | | | | | |
| Flexural | 26 | 26 | 22 | 24 | 25 | 24 |
| strength [MPa] | | | | | | |
| Specific electrical | 243.0 | 21.4 | 23.3 | 24.0 | 24.5 | 24.6 |
| volume resistance | | | | | | |
| [MΩ · cm] at 1 kHz | | | | | | |
| Factor¹⁾ 1 kHz | | 0.09 | 0.10 | 0.10 | 0.10 | 0.10 |
| Specific electrical | 24.9 | 2.2 | 2.4 | 2.5 | 2.5 | 2.5 |
| volume resistance | | | | | | |
| [MΩ · cm] at 10 kHz | | | | | | |
| Factor 10 kHz | | 0.09 | 0.10 | 0.10 | 0.10 | 0.10 |

¹⁾Factor by which the specific electrical volume resistance of a mortar as per 5 examples B1 to B5 is reduced compared to the specific electrical volume resistance of reference mortar Ref. 1, e.g. resistance B1/resistance Ref. 1

TABLE 5
Results when using quartz sand and Desmodur ® CD-L
as polyisocyanate component in the polyurethane matrix

| | Ref. 1 | B6 | B7 | B8 | B9 | B10 |
|---|---|---|---|---|---|---|
| Binder matrix | SD | J | H | F | D | B |
| Sand | Quartz | Quartz | Quartz | Quartz | Quartz | Quartz |
| | sand | sand | sand | sand | sand | sand |
| Compressive | 104 | 102 | 75 | 75 | 82 | 73 |
| strength [MPa] | | | | | | |
| Flexural | 26 | 27 | 23 | 24 | 26 | 27 |
| strength [MPa] | | | | | | |
| Specific electrical | 243.0 | 26.0 | 23.3 | 24.5 | 25.9 | 23.6 |
| volume resistance | | | | | | |
| [MΩ · cm] at 1 kHz | | | | | | |
| Factor¹⁾ 1 kHz | | 0.11 | 0.10 | 0.10 | 0.11 | 0.11 |
| Specific electrical | 24.9 | 2.7 | 2.4 | 2.5 | 2.7 | 2.4 |
| volume resistance | | | | | | |
| [MΩ · cm] at 10 kHz | | | | | | |
| Factor 10 kHz | | 0.11 | 0.10 | 0.10 | 0.11 | 0.10 |

¹⁾see Table 4 above

TABLE 6
Results when using copper slag (CS) and Desmodur ® VL
as polyisocyanate component in the polyurethane matrix

| | Ref. 2 | B11 | B12 | B13 | B14 | B15 |
|---|---|---|---|---|---|---|
| Binder matrix | SD | I | G | E | C | A |
| Sand | CS | CS | CS | CS | CS | CS |
| Compressive | 116 | 93 | 66 | 65 | 82 | 51 |
| strength [MPa] | | | | | | |
| Flexural | 31 | 26 | 20 | 23 | 29 | 21 |
| strength [MPa] | | | | | | |
| Specific electrical | 24.9 | 15.5 | 15.3 | 16.7 | 15.5 | 15.8 |
| volume resistance | | | | | | |
| [MΩ · cm] at 1 kHz | | | | | | |
| Factor¹⁾ 1 kHz | | 0.62 | 0.61 | 0.67 | 0.62 | 0.63 |
| Specific electrical | 3.3 | 1.6 | 1.6 | 1.8 | 1.6 | 1.7 |
| volume resistance | | | | | | |
| [MΩ · cm] at 10 kHz | | | | | | |
| Factor 10 kHz | | 0.48 | 0.48 | 0.55 | 0.48 | 0.52 |

¹⁾see Table 4 above

TABLE 7
Results when using copper slag (CS) and Desmodur ® CD-L
as polyisocyanate component in the polyurethane matrix

| | Ref. 2 | B16 | B17 | B18 | B19 | B20 |
|---|---|---|---|---|---|---|
| Binder matrix | SD | J | H | F | D | B |
| Sand | CS | CS | CS | CS | CS | CS |
| Compressive | 116 | 95 | 68 | 67 | 69 | 63 |
| strength [MPa] | | | | | | |
| Flexural | 31 | 27 | 20 | 20 | 25 | 25 |
| strength [MPa] | | | | | | |
| Specific electrical | 24.9 | 15.8 | 16.1 | 16.3 | 15.5 | 16.1 |
| volume resistance | | | | | | |
| [MΩ · cm] at 1 kHz | | | | | | |
| Factor¹⁾ 1 kHz | | 0.63 | 0.65 | 0.65 | 0.62 | 0.65 |
| Specific electrical | 3.3 | 1.7 | 1.7 | 1.7 | 1.7 | 1.7 |
| volume resistance | | | | | | |
| [MΩ · cm] at 10 kHz | | | | | | |
| Factor 10 kHz | | 0.52 | 0.52 | 0.52 | 0.52 | 0.52 |

¹⁾see Table 4 above

Thermal Conductivity

The thermal conductivities of various grouting mortars were also measured. This was done by producing test specimens having a diameter of 30 mm and a height of 2 mm by pouring into appropriate molds and allowing them to cure at 20° C. for 7 days.

TABLE 8
Results for thermal conductivities

| | Ref. 3 | B21 | B22 | B23 | B24 | B25 | B26 |
|---|---|---|---|---|---|---|---|
| Binder matrix | SD | I | I | I | I | I | I |
| Sand | Quartz sand | | BFS | Raulit | FS | EFS | CS |
| Thermal | 2.8 | 2.9 | 1.1 | 1.1 | 0.9 | 1.0 | 0.9 |
| conductivity | | | | | | | |
| [W/mK]] | | | | | | | |

By using slag instead of quartz sand, the thermal conductivity can be reduced.

Corrosion Resistance

To test the corrosion resistance of the binder compositions and of test specimens produced therefrom, various test specimens were produced as described above and allowed to cure for 7 days at 20° C. Compressive strength was then determined in accordance with ASTM D695.

Thereafter, the test specimens were stored for 21 days (21 d) respectively in pure water (H₂O), in 10% by volume acetic acid (AcOH) or in 50% by weight sodium hydroxide solution (NaOH) and then dried to constant weight. Compressive strength was then determined again in accordance with ASTM D695.

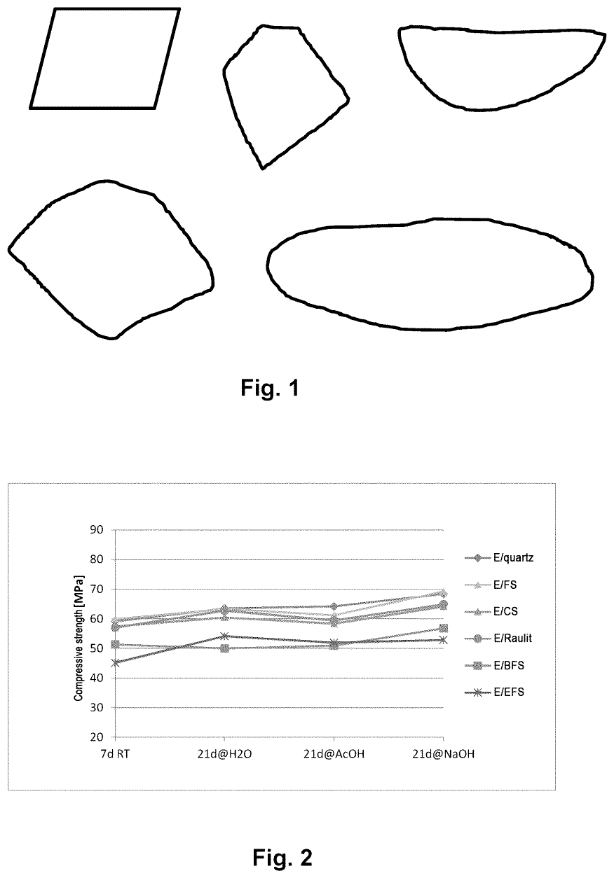

FIG. 2 shows the compressive strengths of test specimens based on polyurethane matrix E and a solid component as described above, with quartz sand, FS, CS, Raulit, BFS, and EFS alternately used as sand.

It can be seen here that the compressive strengths, irrespective of which medium is used (H₂O, AcOH or NaOH), are not only unimpaired but increase during storage.

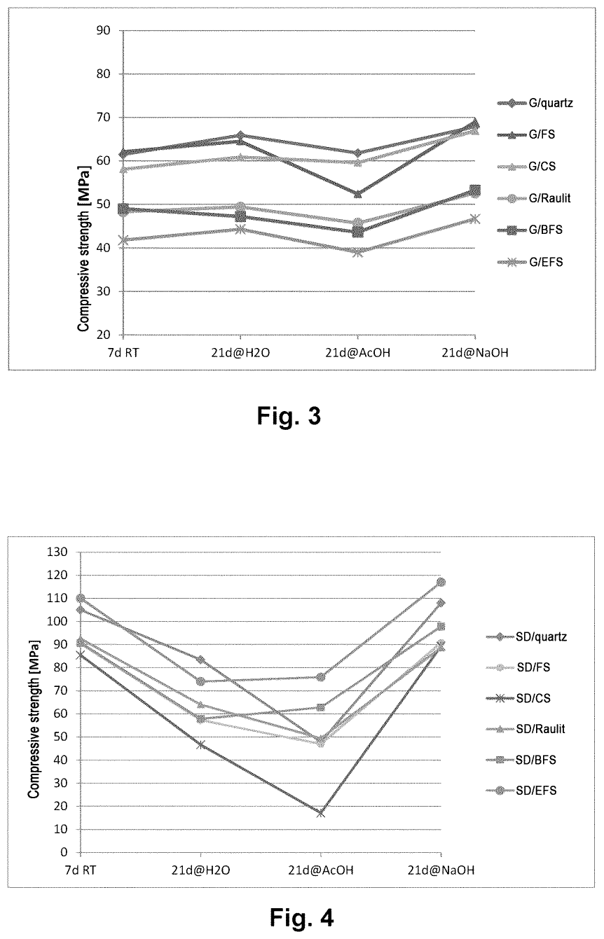

FIG. 3 shows the compressive strengths of test specimens based on polyurethane matrix G and a solid component as described above, with quartz sand, FS, CS, Raulit, BFS, and EFS alternately used as sand.

In this case too, the compressive strengths increase in H₂O and NaOH, whereas in AcOH a slight decrease is discernible for certain solid components.

FIG. 4 shows for comparison the results for test specimens based on epoxy resin matrix SD and a solid component as described above, with quartz sand, FS, CS, Raulit, BFS, and EFS again alternately used as sand.

This shows clearly the sharp decrease in compressive strength on storage in H₂O and AcOH. Only in NaOH is the compressive strength maintained, or where this increases slightly during storage.

Grouting Mortars Having Different Amounts of Polyurethane Matrix

Table 9 shows the compositions and compressive strengths of further grouting mortars in which the amounts of the binder matrix and the solid components were modified.

TABLE 9
Grouting mortars having different amounts
of sand and polyurethane matrix

| | B27 | B28 | B29 | B30 | B31 | B32 |
|---|---|---|---|---|---|---|
| Binder matrix/ | E | E | E | E | E | E |
| Proportion [wt %] | 6.0 | 6.0 | 20.0 | 20.0 | 12.5 | 12.5 |
| Slag/ | CS | EFS | CS | EFS | CS | EFS |
| Proportion [wt %] | 79.9 | 79.9 | 66.9 | 66.9 | 75.4 | 75.4 |
| Mixture of limestone | 14.0 | 14.0 | 13.0 | 13.0 | 12.0 | 12.0 |
| powder and baryte | | | | | | |
| powder [wt %] | | | | | | |
| Polycarboxylate ether | 0.1 | 0.1 | 0.1 | 0.1 | 0.1 | 0.1 |
| solution [wt %] | | | | | | |
| Compressive strength | 36.6 | 18.3 | 40.7 | 31.9 | 55.0 | 33.8 |
| [MPa] | | | | | | |

The results in Table 9 show that a proportion of binder matrix in the region of more than 6.0% by weight is advantageous in respect of compressive strength. In the case of copper slag (CS) and electric furnace slag (EFS), the test with 12.5% by weight of binder matrix shows the highest compressive strength.

Controlled Foaming with Molecular Sieve

To analyze the influence of the proportion of molecular sieve on foaming, the proportion of molecular sieve was in several experiments reduced starting from binder composition B3 (see Table 4; binder matrix E and quartz sand as a sand type). Table 10 gives an overview of the results.

The samples of component A with and without fillers and desiccant were weighed into headspace GC sample vials and a defined amount of dichloromethane added as extractant. After an extraction time of at least one hour at room temperature, the water content of the pure dichloromethane and of the filtered solutions of component A in dichloromethane was determined by coulometric Karl Fischer titration.

TABLE 10
Influence of the proportion of molecular sieve in the polyurethane
matrix E on the foaming, density, and strength of grouting mortars.

| | Proportion of molecular sieve | | | | |
|---|---|---|---|---|---|
| | 4/4 | 3/4 | 2/4 | 1/4 | 0 |
| Concentration of | 10 | 7.5 | 5.0 | 2.5 | 0 |
| molecular sieve powder | | | | | |
| in matrix [wt %] | | | | | |
| Water content [wt %] | 0.13 | 0.11 | 0.14 | 0.10 | 0.10 |
| Density [g/cm³] | 2.48 | 2.43 | 2.38 | 2.25 | 1.84 |
| Foaming [vol %] | 0 | 2 | 4 | 10 | 35 |
| Compressive strength | 74 | 73 | 69 | 55 | 29 |
| [MPa] | | | | | |
| Flexural strength [MPa] | 24 | 25 | 24 | 18 | 12 |

A molecular sieve proportion of “4/4” corresponds to the original proportion of 10% by weight in component A/in the polyurethane matrix (cf. Table 4). In the experiment with “¾”, the proportion was reduced to 7.5% by weight (compensated by increasing the other constituents), in “ 2/4” to 5% by weight, and in “¼” to 2.5% by weight. “0” corresponds to a formulation containing no molecular sieve at all.

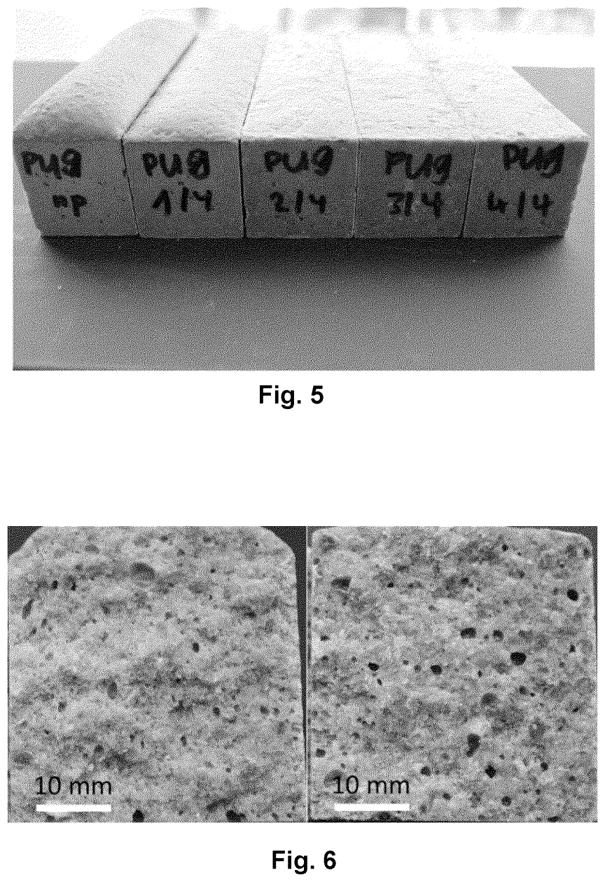

FIG. 5 shows the corresponding, cured grouting mortar. The increase in volume as the proportion of molecular sieve decreases from left to right can be clearly seen.

The left-hand side of FIG. 6 shows a cross section through the reactively foamed sample produced without molecular sieve (sample “0” in Table 10 or the test specimen on the far left in FIG. 5). Shown on the right-hand side in FIG. 6 is a cross section through the non-reactively foamed sample produced with the original amount of 10% by weight of molecular sieve in component A (sample “4/4” in Table 10 and the test specimen on the far right in FIG. 5). The pores that can be seen are the result of outgassing of air dissolved in the binder and dispersed in the binder composition during curing.

Whereas the sample without molecular sieve has fewer pores with larger diameters, the sample with molecular sieve has a greater abundance of smaller pores having a diameter <1 mm.

In addition, microsections of cured grouting mortars were produced and examined by scanning electron microscopy (SEM) with energy-dispersive X-ray analysis (EDX); SEM: Zeiss Sigma 300 VP, electron source: Schottky field emission; detectors: in-lens and secondary electron detector (SE2), variable-pressure (VP) cascade current detector (C2D), high-resolution backscattered electron detector (HDBSD), multimode transmission REM detector (STEM); energy dispersive X-ray spectroscopy: Ametek EDAX, detector: Apollo X-SDD, resolution 127.7 eV).

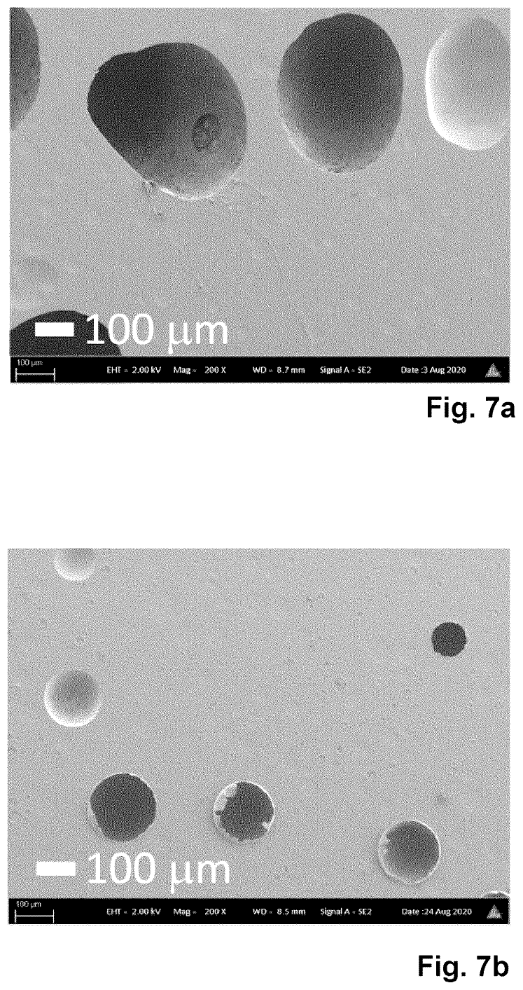

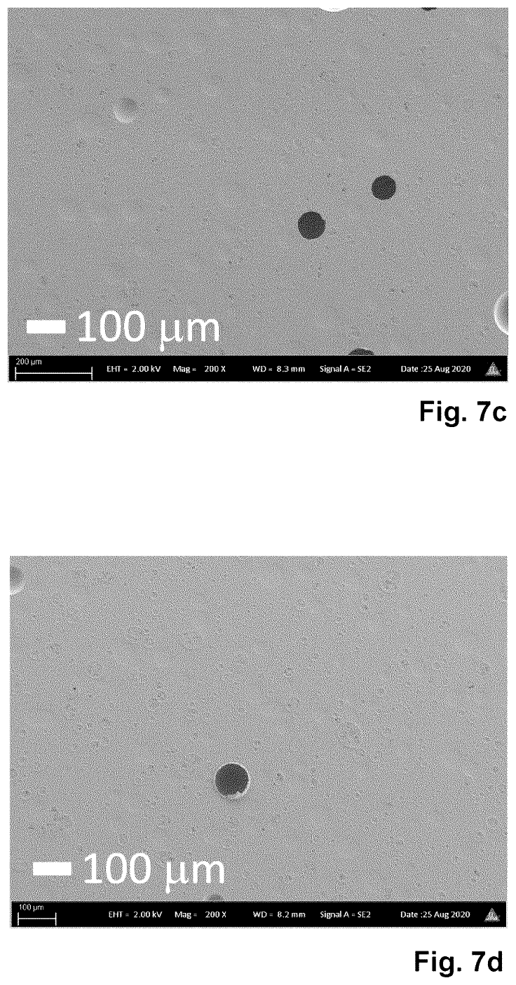

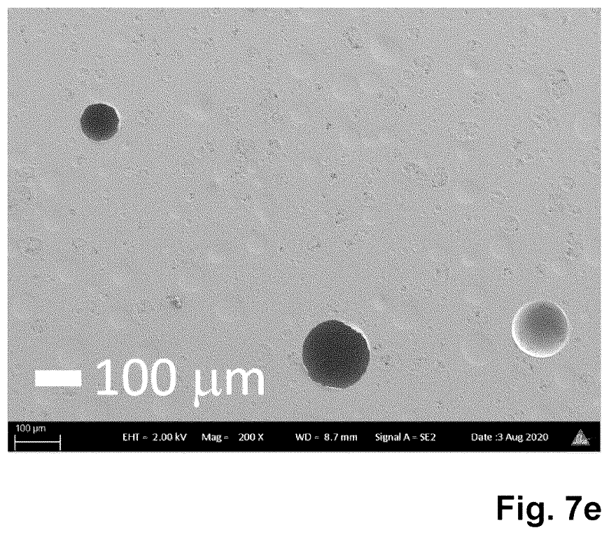

FIGS. 7a-7e show scanning electron microscopy images obtained at a magnification of 200× of the cured polyurethane matrix E containing varying proportions of molecular sieve. The sample without molecular sieve (FIG. 7a) shows irregularly shaped, large air pores having diameters of 200-400 μm. The sample with a ¼ proportion of molecular sieve (FIG. 7b) already has markedly fewer air pores than the sample without molecular sieve and the pores all have a rounder shape. The diameter of the pores varies here within a range of approx. 100-200 μm. The samples with a proportion of 2/4 (FIG. 7c), a proportion of ¾ (FIG. 7d), and a proportion of 4/4 (FIG. 7e) are very similar and have a lower pore density compared to the sample with a molecular sieve proportion of ¼, with pore diameters of mostly around 100 μm.

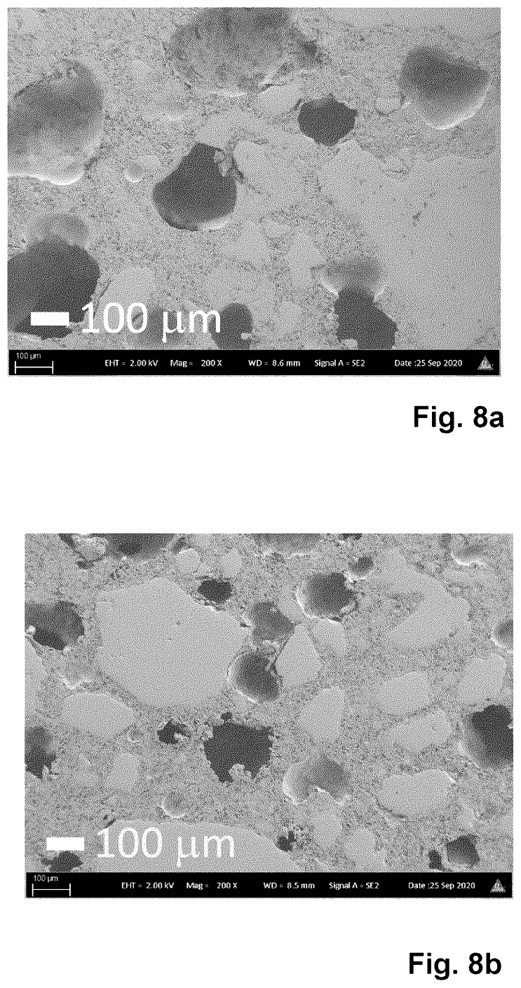

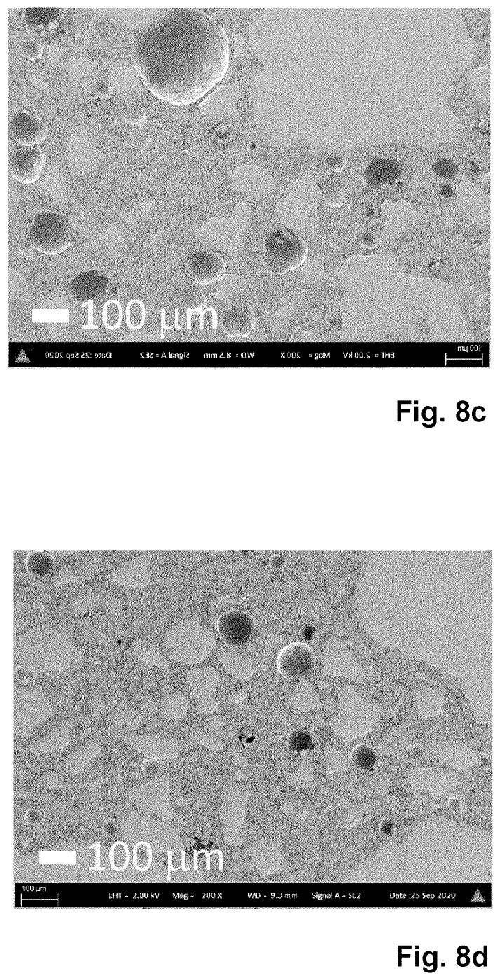

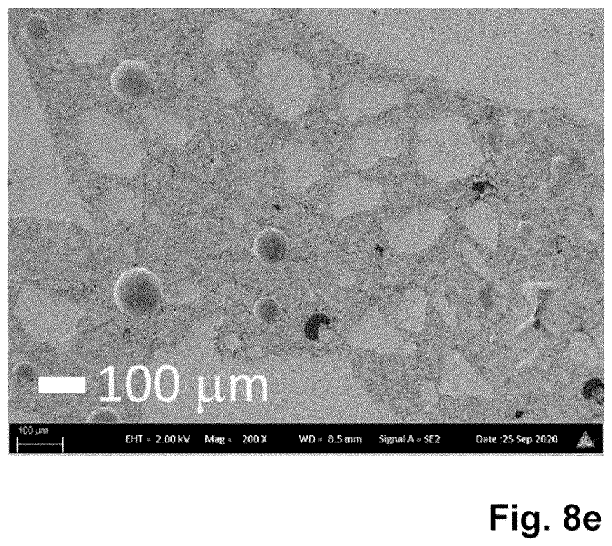

FIGS. 8a-8e show scanning electron microscopy images recorded at a magnification of 200× of samples of the cured binder matrix E and 89% by weight of quartz sand as sand type containing varying proportions of molecular sieve. The sample without molecular sieve (FIG. 8a) shows a high proportion of pores. These are mostly irregular in shape, typically having a diameter of between 50-250 μm. There are also a few pores in the sample that have diameters of 300-700 μm. Many pores appear to connect to adjoining pores. The sample with a molecular sieve proportion of ¼ (FIG. 8b) likewise has a high proportion of pores, although lower than the sample without molecular sieve. The pores are irregular in shape, with diameters of 50-200 μm, in rare instances up to 400 μm. In the sample with a molecular sieve proportion of 2/4 (FIG. 8c), the pore content is further reduced. The shape of the pores is now mostly round, although there are still pores with an irregular shape. The diameter of the pores is between 40 and 150 μm, although pores of up to 250 μm are also found in rare instances. In the sample with a molecular sieve proportion of ¾ (FIG. 8d), the pore content is again greatly reduced and the pore shape is mostly round. The pore sizes vary within a range of 30-120 μm, with pores having a diameter of up to 200 μm also present. The sample with a molecular sieve proportion of 4/4 (FIG. 8e) shows a tendency to slightly fewer pores than the sample with a proportion of ¾. The typical diameter is again slightly reduced, at 30-100 μm (in rare instances up to 200 μm). The shape of the pores is still mostly round.

This shows that the pore structure, the pore density, and the density of the foamed grouting mortar, thus all of the parameters subsumed under the term “foaming”, can be selectively influenced by the molecular sieve.

Controlled Foaming with Calcium Oxide

To analyze the influence of the proportion of calcium oxide on foaming and density, a binder matrix E′ based on matrix E (see Table 1) was provided in which the molecular sieve (Sylosiv®) was replaced by varying amounts of pulverulent calcium oxide. The binder matrix E′ thus produced was then processed together with quartz sand (in analogous manner to experiment B3; Table 4) into grouting mortars, which were investigated in respect of density and foaming. Table 11 gives an overview of the results.

The water content of the samples after mixing was also determined. The samples of component A with and without fillers and desiccant were weighed into headspace GC sample vials and a defined amount of dichloromethane added as extractant. After an extraction time of at least one hour at room temperature, the water content of the pure dichloromethane and of the filtered solutions of component A in dichloromethane was determined by coulometric Karl Fischer titration.

TABLE 11
Influence of the proportion of calcium oxide in the polyurethane
matrix E′ on the foaming and density of grouting mortars.

| | Proportion of calcium oxide | | | | | |
|---|---|---|---|---|---|---|
| | 4/4 | 3/4 | 2/4 | 1/4 | 1/7 | 1/10 |
| Concentration of calcium | 10 | 7.5 | 5.0 | 2.5 | 1.5 | 1.0 |
| oxide in matrix [wt %] | | | | | | |
| Water content [wt %] | — | 0.02 | — | 0.05 | 0.05 | 0.04 |
| Density [g/cm³] | 3.70 | 3.52 | 3.45 | 3.30 | 2.94 | 2.75 |
| Foaming [vol %] | 0 | 5 | 7 | 11 | 21 | 26 |

The results show that the foaming and density can be selectively adjusted via the proportion of calcium oxide in a manner comparable to that with molecular sieve.

1. A curable binder composition comprising a) at least one organic binder comprising a polyisocyanate and a polyol, and b) at least 50% by weight of an inorganic filler F, and c) a desiccant, the proportions by weight being based on 100% by weight of the curable binder composition.

2. The curable binder composition of claim 1, wherein the desiccant is selected from a molecular sieve, calcium oxide, calcium chloride, sodium carbonate, potassium carbonate, calcium sulfate and/or magnesium sulfate.

3. The curable binder composition of claim 1, wherein the desiccant is present in a proportion of not more than 1% by weight, based on 100% by weight of the curable binder composition.

4. The curable binder composition of claim 1, wherein the desiccant is present in a proportion of not more than 15% by weight, based on the total weight of the polyols and of the desiccant together.

5. The curable binder composition of claim 1, wherein the water content in the curable binder composition is not more than 0.5% by weight, based on the total weight of the curable binder composition.

6. The curable binder composition of claim 1, wherein the water content in the curable binder composition is 0.01-0.45% by weight.

7. The curable binder composition of claim 1, wherein the filler F has a particle size of at least 0.1 mm, and wherein at least three different grain fractions are further present, a first grain fraction having a grain size within a range of 0.125-0.25 mm, a second grain fraction having a grain size within a range of 0.5-0.8 mm, and a third grain fraction having a grain size within a range of 2.0-3.15 mm.

8. The curable binder composition of claim 1, wherein the filler F is present in the form of quartz aggregates, slag or a mixture of slag and quartz aggregates, the slag, if present, being selected from the group consisting of blast furnace slags.

9. The curable binder composition of claim 1, wherein an additional filler material different from the filler F is present, the additional filler material having a particle size of not more than 0.1 mm.

10. The curable binder composition of claim 1, wherein the polyisocyanate and the polyol together have a proportion of at least 5% by weight, based on 100% by weight of the curable binder composition.

11. The curable binder composition of claim 1, wherein the organic binder includes at least a mixture of polyols having different OH functionality.

12. The curable binder composition of claim 1, wherein the curable binder composition is curable to afford a cured mineral binder composition having a foam structure.

13. (canceled)

14. The curable binder composition of claim 1, comprising:
3% to 40% by weight of polyisocyanates,
3% to 40% by weight of polyols,
50% to 93.999% by weight of filler F,
0.001-1% by weight of desiccant,
optionally 10% to 40% by weight of additional filler material.
0% to 0.5% by weight of water, and
0% to 15% by weight of further additives,
based on 100% by weight of the curable binder composition.

15. (canceled)

16. The curable binder composition of claim 1, wherein a desiccant content and/or the water content are such that, after curing, a cured binder composition has a foam structure with a density within a range of 1.7-3.9 g/cm³.

17. A multicomponent system for producing the curable binder composition of claim 1, comprising at least one polyisocyanate component comprising at least one polyisocyanate, and at least one polyol component comprising at least one polyol, wherein the filler F, the desiccant, and optionally further ingredients are present in the polyisocyanate components, in the polyol components and/or in any further component optionally present.

18. A cured binder composition obtained by curing of the curable binder composition of claim 1 or by mixing of the components and curing of the multicomponent system comprising at least one polyisocyanate component comprising at least one polyisocyanate, and at least one polyol component comprising at least one polyol, wherein the filler F, the desiccant, and optionally further ingredients are present in the polyisocyanate components, in the polyol components and/or in any further component optionally present.

19. The cured binder composition as claimed in claim 18, which is present in the form of a foamed body.

20. The binder composition as claimed in claim 18, wherein pores having a pore diameter in the range of <4 mm are present in the cured binder composition.
